(19) United States
(12) Patent Application Publication
(10) Pub. No.: US 2014/0261778 A1
(43) Pub. Date: Sep. 18, 2014

(54) High Integrity Pressure Protection System (HIPPS) Manifold System and Method

(71) Applicant: Pentair Valves & Controls UK Limited, Aberdeen (GB)

(72) Inventor: James Hamilton, West Yorkshire (GB)

(21) Appl. No.: 14/211,800

(22) Filed: Mar. 14, 2014

Related U.S. Application Data
(60) Provisional application No. 61/785,472, filed on Mar. 14, 2013.

(51) Int. Cl. F16K 17/00

(52) U.S. Cl. CPC F16K 17/00
USPC 137/461

(57) ABSTRACT

Embodiments of the invention provide a high integrity pressure protection system (HIPPS) manifold including a housing providing a flow path between a process fluid line and a sensor, a first ball valve positioned within the housing and selectively allowing and inhibiting flow through the flow path, and a second ball valve positioned within the housing and selectively allowing and inhibiting flow through the flow path.

### CROSS REFERENCE TO RELATED APPLICATIONS

This application claims the benefit of U.S. Provisional Patent Application No. 61/785,472 filed on Mar. 14, 2013, the entire contents of which are incorporated herein by reference.

### BACKGROUND

A high integrity pressure protection system (HIPPS) is a type of safety instrumented system (SIS) designed to prevent over-pressurization of a plant, such as a chemical plant or oil refinery. The HIPPS is arranged to shut off a source of high pressure before a predetermined upper threshold pressure of the system is exceeded. In this way, the HIPPS inhibits a loss of containment through rupture (explosion) of a line or vessel. The HIPPS is a barrier between a high-pressure and a low-pressure section of the plant.

In conventional systems, over-pressure is dealt with through relief systems. A relief system will open an alternative outlet for the fluids in the system once the upper threshold pressure is exceeded, to avoid further build-up of pressure in the protected system. This alternative outlet generally leads to a flare or venting system to safely dispose of the excess fluids. A relief system aims to remove any excess inflow of fluids for safe disposal, whereas a HIPPS aims to stop the inflow of excess fluids and contain fluid within the system.

Conventional relief systems have disadvantages such as release of (flammable and toxic) process fluids or their combustion products into the environment. With environmental awareness increasing, relief systems are not always an acceptable solution. Many other reasons exist why a plant may be best outfitted with a HIPPS.

FIG. 1 illustrates a conventional HIPPS installation 10 that includes a process fluid line 14, three independent pressure transmitters 18, 22, 26 each monitoring the pressure within the process fluid line 14, two controlled blocking valves 30, 34 that selectively allow and inhibit flow through the process fluid line 14, and a logic solving circuit 38 in communication with the pressure transmitters 18, 22, 26 and the blocking valves 30, 34. An alarm 42 is also connected to the logic solving circuit 38.

In operation, the conventional HIPPS installation 10 uses the pressure transmitters 18, 22, 26 to monitor a pressure within the line 14. The logic solving circuit 38 receives signals from the pressure transmitters 18, 22, 26 indicative of the pressure. The logic solving circuit 38 then compares the measured pressures to a threshold value. If two or more of the pressure transmitters 18, 22, 26 indicate a pressure above the threshold value, then the logic solving circuit 38 will control the blocking valves 30, 34 via actuators and/or solenoids to close and inhibit flow through the line 14. The alarm 42 is also sounded so that a plant manager is alerted of the activation of the HIPPS installation 10.

### SUMMARY

The invention is directed to a manifold for connecting a pressure transmitter to a process fluid line in a HIPPS installation. One embodiment of the invention is directed to a high integrity pressure protection system (HIPPS) manifold that includes a housing providing a flow path between a process fluid line and a sensor, a first ball valve positioned within the housing and selectively allowing and inhibiting flow through the flow path, and a second ball valve positioned within the housing and selectively allowing and inhibiting flow through the flow path.

Another embodiment of the invention provides a high integrity pressure protection system (HIPPS) manifold that includes a housing providing a flow path between a process fluid line, a vent, and a sensor. A first valve is positioned within the housing and selectively allows and inhibits flow through the flow path. The first valve includes a first cam. A second valve is positioned within the housing and selectively allows and inhibits flow through the flow path. The second valve includes a second cam that interacts with the first cam. A third valve is positioned within the housing and selectively allows and inhibits flow through the flow path. The third valve includes a third cam that interacts with the second cam.

Another embodiment of the invention provides a high integrity pressure protection system (HIPPS) installation that includes three HIPPS manifolds. Each HIPPS manifold includes a housing that provides a flow path between a process fluid line, a vent, and a sensor. A first valve is positioned within the housing and selectively allows and inhibits flow through the flow path. A second valve is positioned within the housing and selectively allows and inhibits flow through the flow path. A third valve is positioned within the housing and selectively allows and inhibits flow through the flow path. The HIPPS manifold further includes a locking mechanism with a keyhole actuatable between a locked position and an unlocked position. A locking member is movable in response to the keyhole between a locked position and an unlocked position, thereby allowing actuation of the first valve when in the open position and inhibiting actuation of the first valve when in the locked position. The HIPPS installation further includes three individual keys, each key corresponding to one of the three keyholes and configured to actuate the associated locking mechanism.

Another embodiment of the invention provides a high integrity pressure protection system (HIPPS) installation that includes three HIPPS manifolds. Each HIPPS manifold includes a housing that provides a flow path between a process fluid line, a vent, and a sensor. A first valve is positioned within the housing and selectively allows and inhibits flow through the flow path. A second valve is positioned within the housing and selectively allows and inhibits flow through the flow path. A third valve is positioned within the housing and selectively allows and inhibits flow through the flow path. The HIPPS manifold further includes a locking mechanism with a keyhole actuatable between a locked position and an unlocked position. A locking member is movable in response to the keyhole between a locked position and an unlocked position, thereby allowing actuation of the first valve when in the open position and inhibiting actuation of the first valve when in the locked position. The HIPPS installation further includes a single key operable to fit in each of the three keyholes and configured to actuate the associated locking mechanism.

Another embodiment of the invention provides a method of operating a high integrity pressure protection system (HIPPS) manifold. The method includes inserting a key into a locking mechanism, actuating a locking member from a locked position to an open position, actuating a first valve from an open position to a closed position, actuating a second valve from an isolating position to a vent position after actuating the first valve to the closed position, and actuating a third valve from an open position to a closed position after actuating the second valve to the vent position.

### DESCRIPTION OF THE DRAWINGS

FIG. 1 is a schematic representation of a typical HIPPS installation.

FIG. 2 is a perspective view of a HIPPS manifold according to the invention.

FIG. 3 is a side view of the HIPPS manifold of FIG. 2.

FIG. 4 is a section view of the HIPPS manifold of FIG. 2 taken along the line C-C in FIG. 3.

FIG. 5 is a front view of the HIPPS manifold of FIG. 2.

FIG. 6 is a section view of the HIPPS manifold of FIG. 2 taken along the line A-A in FIG. 5.

FIG. 7 is a detail view of the HIPPS manifold of FIG. 2 showing the area denoted by circle B in FIG. 6.

FIG. 8 is another perspective view of the HIPPS manifold of FIG. 2.

FIG. 9 is a pressure transmitter assembly including three HIPPS manifolds of FIG. 2.

FIG. 10 is another pressure transmitter assembly including three HIPPS manifolds of FIG. 2.

FIG. 11 is a schematic representation of a HIPPS installation according to the invention.

FIG. 12 is a schematic representation of the HIPPS manifold of FIG. 2 in a first position.

FIG. 13 is a schematic representation of the HIPPS manifold of FIG. 2 in a second position.

FIG. 14 is a schematic representation of the HIPPS manifold of FIG. 2 in a third position.

FIG. 15 is a schematic representation of the HIPPS manifold of FIG. 2 in a fourth position.

FIG. 16 is a flow diagram of a method of operating the HIPPS manifold of FIG. 2.

FIG. 17 is a top view of valve cams of the HIPPS manifold of FIG. 2 in a first position.

FIG. 18 is a top view of valve cams of the HIPPS manifold of FIG. 2 in a second position.

FIG. 19 is a top view of valve cams of the HIPPS manifold of FIG. 2 in a third position.

FIG. 20 is a top view of valve cams of the HIPPS manifold of FIG. 2 in a fourth position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

FIG. 2 illustrates a HIPPS manifold 50 that includes a housing 54, a locking mechanism 58, a first valve 62, a second valve 66, and a third valve 70.

As generally shown in FIG. 6, the housing 54 defines a line port 74 arranged for connection to a process fluid line 78 (see FIGS. 10-15), a sensor port 82 arranged to receive an adapter 86 that couples a sensor in the form of a pressure transmitter 90 (see FIGS. 9 and 10) to the HIPPS manifold 50, a vent port 94 (see FIG. 4) arranged to receive an adapter 98 that couples the HIPPS manifold 50 to a vent or recovery line (not shown) or may be plugged (as shown in FIG. 10), a central passageway 102 providing communication between the line port 74 and the sensor port 82, a first valve cavity 106, a second valve cavity 110, and a third valve cavity 114. The first valve cavity 106, the second valve cavity 110, and the third valve cavity 114 are arranged in fluid communication along the central passageway 102. The vent port 94 is arranged in fluid communication with the second valve cavity 110. The housing 54 additionally defines a first valve bore 118, a second valve bore 122, and a third valve bore 126 each in communication with the corresponding valve cavity 106, 110, 114.

The locking mechanism 58 includes a lock housing 130, a key interface 134, a plunger 138 movable between a locked or extended position and an unlocked or retracted position, a spacer block 142, and a proximity switch/sensor 158. The lock housing 130 includes an aperture 146 sized to slidingly receive the plunger 138 and mechanical linkage (not shown) connecting the key interface 134 with the plunger 138. In other embodiments, the mechanical linkage could be replaced with an electrical system such as a solenoid operated mechanism.

The key interface 134 includes a keyhole 150 arranged to receive a key 154 (see FIG. 8). In one embodiment, the key 154 is a plunger or barrel type key that physically matches the pattern of the keyhole 150. Each HIPPS manifold 50 requires a different key 154. Once inserted into a corresponding keyhole 150, the key 154 is actuatable between a locked position corresponding to the plunger 138 being in the locked position and an unlocked position corresponding to the plunger 138 being in the unlocked position.

As shown in FIG. 5, the proximity switch/sensor 158 proximity switch/sensor 158 is focused on the plunger 138. A two wire lead 162 provides signals from the proximity switch/sensor 158 to other portions of the HIPPS system. The signals sent by the proximity switch/sensor 158 are indicative of the state of the plunger 138 (i.e., locked or unlocked).

The first valve 62 includes a two-way first ball valve 166 disposed within the first valve cavity 106, a first valve shaft 170 coupled to the first ball valve 166 and disposed within the first valve bore 118, a first cam 174 coupled to the first valve shaft 170, and a first handle 178 coupled to the first cam 174. A first end adapter 182 is threaded into the housing 54 to maintain the first ball valve 166 within the first valve cavity 106.

The second valve 66 includes a three-way second ball valve 186 disposed within the second valve cavity 110, a second valve shaft 190 coupled to the second ball valve 186 and disposed within the second valve bore 122, a second cam 194 coupled to the second valve shaft 190, and a second handle 198 coupled to the second cam 194. As shown in FIG. 4, the vent port adapter 98 is threaded into the vent port 94 to maintain the second ball valve 186 within the second valve cavity 110.

The third valve 70 includes a two-way third ball valve 202 disposed within the third valve cavity 114, a third valve shaft 206 coupled to the third ball valve 202 and disposed within the third valve bore 126, a third cam 210 coupled to the third valve shaft 206, and a third handle 214 coupled to the third cam 210. The pressure transmitter adapter 86 is threaded into the sensor port 82 to maintain the third ball valve 202 within the third valve cavity 114.

The handles 178, 198, 214 are arranged so that they do not interfere with one another during actuation.

As shown in FIG. 17, the first cam 174 defines a lock receiving feature 218 arranged to receive the plunger 138 and inhibit actuation of the first valve 62 when the plunger 138 is in the locked position. The first cam 174 further defines a first guide aperture 222 arranged to receive a guide pin 226, a cam portion 230, and a notch 234. The second cam 194 defines a second guide aperture 238 arranged to receive a guide pin 242, a cam portion 246, and a notch 250. The third cam 210 defines a third guide aperture 254 arranged to receive a guide pin 258, a cam portion 262, and a notch 266.

FIG. 9 illustrates a HIPPS installation 267 that includes three HIPPS manifolds 50 arranged in an enclosure 268 and connected to a common tap line 270 that is in fluid communication with the process fluid line 78.

FIG. 10 illustrates an HIPPS installation 269 wherein three HIPPS manifolds 50 are each in direct fluid communication with the process fluid line 78.

FIG. 11 illustrates a schematic representation of the HIPPS installation 267 including three HIPPS manifolds 50. Each HIPPS manifold 50 is in fluid communication with the tap line 270 and selectively provides process fluid to the pressure transmitter 90. Each proximity switch/sensor 158 monitors the state of the locking mechanism 58 and communicates the state to a lock controller 274. The lock controller 274 is operable to sound an alarm if a proximity switch/sensor 158 indicates a locking mechanism 58 is unlocked. Each pressure transmitter 90 is in communication with a pressure controller 278 and provides signals thereto that are indicative of a pressure within the HIPPS manifold 50. The pressure controller 278 includes a predetermined threshold pressure and compares the indicated pressures sent from the three pressure transmitters 90 to the predetermined pressure threshold. If two of the three pressure transmitters indicate a pressure within the line 78 that is above the threshold pressure, the pressure controller 278 will activate the HIPPS installation (e.g., closing blocking valves to isolate the pressure).

Operation of the HIPPS manifold 50 will be described below with respect to FIGS. 12-20. FIGS. 12-15 are schematic representations of fluid flow paths within the HIPPS manifold 50, while FIGS. 17-20 show the positions of the cams 174, 194, 210 corresponding to the positions shown in FIGS. 12-15.

FIG. 16 illustrates a method of operating the HIPPS manifold 50. The method 300 describes how one actuates the HIPPS manifold 50 to a closed position inhibiting fluid communication between the process fluid line 78 and the pressure transmitter 90, from an open position allowing fluid communication between the process fluid line 78 and the pressure transmitter 90. The key 154 is inserted in the keyhole 150 (at 304) and actuated to the unlocked position thereby moving the plunger 138 to the unlocked position (at 308). With the locking mechanism 58 unlocked, the proximity switch/sensor 158 will indicate an unlocked manifold 50 to the lock controller 274. If the action is unexpected, an alarm will sound alerting the installation site of the unlocked HIPPS manifold 50.

After unlocking the locking mechanism 58, the first valve 62 is free to be actuated. The first valve 62 is rotated, via the first handle 178, 90 degrees clockwise from an open position to a closed position (at 312). By rotating the first valve 62, the cam portion 230 is moved out of the proximity of the second valve 66 and instead the notch 234 is presented to the second valve 66. As shown in FIGS. 13 and 18, the first valve 62 then inhibits flow through the central passageway 102.

With the cam portion 230 of the first valve 62 no longer blocking actuation of the second valve 66, the second valve 66 is rotated 180 degrees clockwise (at 316) from an isolating position to a vent position, so that the cam portion 246 of the second valve 66 is moved away from the third valve 70 and is positioned adjacent the notch 234 of the first valve 62. The notch 250 of the second valve 66 is then presented to the third valve 70. As shown in FIGS. 14 and 19, the first valve 62 still inhibits flow through the central passageway 102 while the second valve 66 allows communication between the first valve 62 and the third valve 70 via the central passageway 102 and allows fluid communication to the vent port 94.

With the cam portion 246 of the second valve 66 no longer blocking actuation of the third valve 70, the third valve 70 is rotated 90 degrees clockwise (at 320) from an open position to a closed position. As shown in FIGS. 15 and 20, the first valve 62 inhibits flow through the central passageway 102, the second valve 66 allows communication between the first valve 62 and the third valve 70 via the central passageway and allows fluid communication to the vent port 94, and the third valve 70 inhibits flow from the central passageway 102 to the sensor port 82.

The above described HIPPS manifold 50 meets the Safety Integrity Level (SIL) 2 standard if used alone, the SIL 3 standard if used with two manifolds 50 in series, and the SIL 4 standard if used in a three-valve arrangement (e.g., as shown in FIGS. 9-11). It includes a controllable locking mechanism 58 and only allows actuation of the valve via a set sequence. The HIPPS manifold 50 also includes a proximity switch/sensor 158 that communicates to the electronic system of the HIPPS installation (e.g., 267) the state of the locking mechanism 58. Each locking device (e.g., locking mechanism 58) requires an individual key 154. In an alternative embodiment, a master key 154 may be used to access more than one HIPPS manifold 50. The disclosed embodiments are only examples of configurations that are conceivable within the scope of the invention. Other arrangements are possible. For example, one skilled in the art could conceivably arrange the invention such that a single HIPPS manifold 50 could meet the SIL 3 standard.

Conventional HIPPS manifolds utilize needle valve technology. Some embodiments of the invention provide an easier to use and more robust valve type (e.g., ball valves). The ball valves provide a larger flow path to the pressure transmitters, a more reliable and robust structure, and an easier to actuate system. The ball valves can also be arranged to match piping class specifications with a fully roddable design for ease of maintenance.

Conventional HIPPS installations 10 include a slide selector or track selector system that allows only one HIPPS manifold to be isolated (i.e., moved to the closed position as shown in FIGS. 15 and 20) at a time. The inventive HIPPS manifold 50 allows a plurality of manifolds 50 to be isolated simultaneously if used in conjunction with a master key 154. This may speed maintenance and testing operations.

Alternatively, the HIPPS installation (e.g., installation 267 of FIG. 9) can be designed so that only one HIPPS manifold 50 may be accessed at one time. In such a situation, the electrical system may be programmed to close the blocking valves if more than one HIPPS manifold 50 is unlocked simultaneously. Additionally, when in the unlocked position, the locking mechanism 58 may retain the key 154 within the keyhole 150 and inhibit its removal thereby inhibiting the key 154 from unlocking other HIPPS manifolds 50 when the currently unlocked HIPPS manifold 50 is unlocked.

The cams 174, 194, 210 and the corresponding handles 178, 198, 214 are welded together. In other embodiments, the handles may be separate from the cams.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set fourth in the following claims.

1. A high integrity pressure protection system (HIPPS) manifold comprising:
a housing providing a sensor flow path between a process fluid line and a sensor, and a vent flow path;
a first valve positioned within the housing and selectively allowing and inhibiting flow through the sensor flow path, the first valve including a first cam;
a second valve positioned within the housing, providing flow along the sensor flow path, and selectively allowing and inhibiting flow to the vent flow path, the second valve including a second cam; and
a third valve positioned within the housing and selectively allowing and inhibiting flow through the sensor flow path, the third valve including a third cam, the first cam interacting with the second cam to inhibit movement of the second valve, and the second cam interacting with the third cam to inhibit movement of the third valve.

2. The HIPPS manifold of claim 1, wherein the HIPPS manifold is actuatable between an open position and a closed position, wherein to move the HIPPS manifold from the open position to the closed position the first valve must be moved first, the second valve moved second, and the third valve moved third.

3. The HIPPS manifold of claim 2, wherein the first valve is rotatable ninety degrees, the second valve is rotatable one-hundred-eighty degrees, and the third valve is rotatable ninety degrees.

4. The HIPPS manifold of claim 2, wherein when the HIPPS manifold is arranged in the open position, flow is provided along the sensor flow path between the process fluid line and the sensor, and
wherein when the HIPPS manifold is arranged in the closed position, flow is inhibited along the sensor flow path between the process fluid line and the sensor by the first valve and the third valve.

5. The HIPPS manifold of claim 4, wherein the HIPPS manifold is actuatable to a vent position wherein the first valve inhibits flow along the sensor flow path, the second valve provides flow along the sensor flow path and the vent flow path, and the third valve provides flow along the sensor flow path such that the sensor is in fluid communication with the vent flow path and the process fluid line is inhibited from communication to the sensor flow path.

6. The HIPPS manifold of claim 1, wherein the first valve is movable between a first position wherein flow is provided along the sensor flow path, and a second position wherein flow is inhibited along the sensor flow path,
wherein the second valve is movable between a first position wherein flow is provided along the sensor flow path and flow is inhibited along the vent flow path, and a second position wherein flow is provided along the sensor flow path and flow is provided along the vent flow path, and
wherein the third valve is movable between a first position wherein flow is provided along the sensor flow path, and a second position wherein flow is inhibited along the sensor flow path.

7. The HIPPS manifold of claim 1, further comprising a locking mechanism that interacts with the first valve to selectively inhibit actuation of the first valve.

8. The HIPPS manifold of claim 7, wherein the locking mechanism includes a key interface arranged to inhibit unauthorized actuation of the locking mechanism.

9. The HIPPS manifold of claim 1, wherein the first valve is a ball valve, the second valve is a ball valve, and the third valve is a ball valve.

10. The HIPPS manifold of claim 1, wherein the first valve is a two-way ball valve, the second valve is a three-way ball valve, and the third valve is a two-way ball valve.

11. A high integrity pressure protection system (HIPPS) installation comprising:
three HIPPS manifolds, each including
a housing providing a flow path between a process fluid line, a vent, and a sensor,
a first valve positioned within the housing and selectively allowing and inhibiting flow through the flow path,
a second valve positioned within the housing and selectively allowing and inhibiting flow through the flow path,
a third valve positioned within the housing and selectively allowing and inhibiting flow through the flow path, and
a locking mechanism that includes a keyhole actuatable between a locked position and an unlocked position, a locking member movable in response to the keyhole between a locked position and an unlocked position, the locking member allowing actuation of the first valve when in the open position and inhibiting actuation of the first valve when in the locked position; and
three individual keys, each one of the three individual keys corresponding to one of the three keyholes and configured to actuate the associated locking mechanism.

12. The HIPPS installation of claim 11, wherein each locking mechanism further includes a monitoring device that monitors the state of the locking mechanism and sends an alarm signal when the locking member is moved to the unlocked position.

13. The HIPPS installation of claim 11, wherein each first valve includes a first cam, each second valve includes a second cam, and each third valve includes a third cam, the first cam interacting with the second came to selectively inhibit the actuation of the second valve, the second cam interacting with the third cam to selectively inhibit the actuation of the third valve.

14. The HIPPS installation of claim 11, wherein each first valve is movable between a first position wherein flow is provided along the flow path, and a second position wherein flow is inhibited along the flow path,
wherein each second valve is movable between a first position wherein flow is provided between the first valve and the third valve and flow is inhibited to the vent, and a second position
wherein flow is provided between the first valve the third valve and the vent, and wherein each third valve is movable between a first position wherein flow is provided along the flow path, and a second position wherein flow is inhibited along the flow path.

15. The HIPPS installation of claim 11, wherein each HIPPS manifold is actuatable between an open position, a vent position, and a closed position, wherein to move the HIPPS manifold out of the open position the first valve must be moved first, the second valve moved second, and the third valve moved third,
wherein when the HIPPS manifold is arranged in the open position, flow is provided along the flow path between the process fluid line and the sensor and flow is inhibited to the vent,
wherein when the HIPPS manifold is arranged in the closed position, flow is inhibited along the flow path between the process fluid line and the sensor by the first valve and the third valve, and
wherein when the HIPPS manifold is arranged in the vent position, the first valve inhibits flow along the flow path, the second valve provides flow between the first valve and the third valve and to the vent, and the third valve provides flow along the flow path such that the sensor is in fluid communication with the vent and the process fluid line is inhibited from communication to the flow path.

16. A high integrity pressure protection system (HIPPS) installation comprising:
three HIPPS manifolds, each including
a housing providing a flow path between a process fluid line, a vent, and a sensor,
a first valve positioned within the housing and selectively allowing and inhibiting flow through the flow path,
a second valve positioned within the housing and selectively allowing and inhibiting flow through the flow path,
a third valve positioned within the housing and selectively allowing and inhibiting flow through the flow path, and
a locking mechanism that includes a keyhole actuatable between a locked position and an unlocked position, a locking member movable in response to the keyhole between a locked position and an unlocked position, the locking member allowing actuation of the first valve when in the open position and inhibiting actuation of the first valve when in the locked position; and
a single key operable to fit in each of the three keyholes and configured to actuate the associated locking mechanism.

17. The HIPPS installation of claim 16, wherein each locking mechanism further includes a monitoring device that monitors the state of the locking mechanism and sends an alarm signal when the locking member is moved to the unlocked position.

18. The HIPPS installation of claim 16, wherein each first valve includes a first cam, each second valve includes a second cam, and each third valve includes a third cam, the first cam interacting with the second came to selectively inhibit the actuation of the second valve, the second cam interacting with the third cam to selectively inhibit the actuation of the third valve.

19. The HIPPS installation of claim 16, wherein each first valve is movable between a first position wherein flow is provided along the flow path, and a second position wherein flow is inhibited along the flow path,
wherein each second valve is movable between a first position wherein flow is provided between the first valve and the third valve and flow is inhibited to the vent, and a second position wherein flow is provided between the first valve the third valve and the vent, and
wherein each third valve is movable between a first position wherein flow is provided along the flow path, and a second position wherein flow is inhibited along the flow path.

20. The HIPPS installation of claim 16, wherein each HIPPS manifold is actuatable between an open position, a vent position, and a closed position, wherein to move the HIPPS manifold out of the open position the first valve must be moved first, the second valve moved second, and the third valve moved third,
wherein when the HIPPS manifold is arranged in the open position, flow is provided along the flow path between the process fluid line and the sensor and flow is inhibited to the vent,
wherein when the HIPPS manifold is arranged in the closed position, flow is inhibited along the flow path between the process fluid line and the sensor by the first valve and the third valve, and
wherein when the HIPPS manifold is arranged in the vent position, the first valve inhibits flow along the flow path, the second valve provides flow between the first valve and the third valve and to the vent, and the third valve provides flow along the flow path such that the sensor is in fluid communication with the vent and the process fluid line is inhibited from communication to the flow path.
